(19) United States
(12) Patent Application Publication
(10) Pub. No.: US 2022/0335390 A1
(43) Pub. Date: Oct. 20, 2022

(54) DEVICE AND METHOD FOR PROVIDING WAITING SESSION COUPLED TO MEETING SESSION OF MEETING SERVER ON ONLINE EXHIBITION

(71) Applicant: EZ PMP CO. LTD, Seoul (KR)

(72) Inventors: Sangsoon KIM, Seoul (KR); Yoontae KIM, Seoul (KR)

(73) Assignee: EZ PMP CO. LTD, Seoul (KR)

(21) Appl. No.: 17/722,284

(22) Filed: Apr. 15, 2022

(30) Foreign Application Priority Data
Apr. 16, 2021 (KR) 10-2021-0049513

(51) Int. Cl. G06Q 10/10; G06Q 30/02

(52) U.S. Cl. CPC G06Q 10/1095; G06Q 30/0281

(57) ABSTRACT

Disclosed is a device for managing a meeting between an exhibitor and a buyer in a virtual exhibition. The device includes: a communication unit configured to exchange data with an exhibitor terminal of an exhibitor and a buyer terminal of a buyer, a storage unit configured to store at least one command, and a control unit configured to control a device according to the at least one command, and the device generates a meeting schedule data representing a meeting schedule between the exhibitor and the buyer, stores the meeting schedule data in a database, generates a waiting session based on the meeting schedule data, transmits a waiting session address for connecting to the writing session to the exhibitor terminal and the buyer terminal, and transmits a meeting session address for connecting to a meeting session.

### TECHNICAL FIELD

The present disclosure relates to a device and a method for providing a waiting session interlocked with a meeting session of a meeting server in an online exhibition.

### BACKGROUND ART

An exhibition refers to an event that exhibits, sells, promotes, and advertises various items and technologies related to an industry for promoting the industry. In the exhibition, there are exhibitors who want to exhibit their items or technologies and buyers who want to view, consult, or buy the exhibited items or technologies. An organizer of the exhibition organizes the exhibitors' items or technologies to be well exhibited and strives to promote interaction between the exhibitor and the buyer.

A conventional exhibition held in an offline place is conducted in such a manner that the exhibitor only needs to exhibit his or her items in his or her booth provided and the buyer visits the exhibitor's booth which he or she is interested in to examine the items, and then conducts a meeting directly with the exhibitor. Therefore, the organizer of the exhibition less needs to directly manage each meeting between the exhibitor and the buyer and there is also less concern about the no-show.

On the other hand, in an online exhibition held online, a separate process for conducting and managing the meeting between the exhibitor and the buyer is required because the exhibitor and the buyer may not meet in person. In addition, there is a problem in that it is necessary to monitor the progress of each stage of the meeting between the exhibitor and the buyer.

### SUMMARY OF INVENTION

### Technical Problem

An object of the present disclosure is to provide a device and a method for easily conducting and managing a meeting between an exhibitor and a buyer in an online exhibition held online.

Another object of the present disclosure is to provide a device and a method, which may set a meeting schedule between an exhibitor and a buyer in an online exhibition held online, provide a waiting session corresponding to the meeting schedule, and conduct and manage a meeting between the exhibitor and the buyer through the waiting session.

### Solution to Problem

A device for managing a meeting between an exhibitor and a buyer in an online exhibition according to exemplary embodiments of the present disclosure includes: a communication unit configured to exchange data with an exhibitor terminal of the exhibitor and a buyer terminal of the buyer, a storage unit configured to store at least one command, and a control unit configured to control the device according to the at least one command, in which the device generates meeting schedule data representing a meeting schedule between the exhibitor and the buyer, stores the meeting schedule data in a database, generates a waiting session based on the meeting schedule data, transmits a waiting session address for connecting to the waiting session to the exhibitor terminal and the buyer terminal, and transmits a meeting session address for connecting to the meeting session in which the meeting between the exhibitor and the buyer is conducted to the exhibitor terminal and the buyer terminal when the exhibitor terminal and the buyer terminal connect to the waiting session under the control of the control unit.

A method for operating a device for managing a meeting between an exhibitor and a buyer in an online exhibition according to exemplary embodiment of the present disclosure includes: generating a meeting schedule data representing a meeting schedule between an exhibitor and a buyer in response to a request from an exhibitor terminal of the exhibitor or a buyer terminal of the buyer and storing the meeting schedule data in a database, generating a waiting session based on the meeting schedule data and transmitting a waiting session address for connecting to the waiting session to the exhibitor terminal and the buyer terminal, monitoring whether the exhibitor terminal and the buyer terminal have connected to the waiting session, and transmitting a meeting session address for connecting to a meeting session in which a meeting between the exhibitor and the buyer is conducted to the exhibitor terminal and the buyer terminal when the exhibitor terminal and the buyer terminal connect to the waiting session.

### Advantageous Effects of Invention

According to the exemplary embodiments of the present disclosure, it is possible to provide the waiting session according to the meeting schedule of the exhibitor and the buyer in the online exhibition and to easily know whether the exhibitor and the buyer have connected to the waiting session by monitoring the provided waiting session.

According to the exemplary embodiments of the present disclosure, since the address for connecting to the meeting session is provided when both the exhibitor and the buyer connect to the waiting session, the exhibitor and the buyer may conduct the meeting immediately without waiting for each other when receiving the address for connecting to the meeting session.

According to the exemplary embodiments of the present disclosure, it is possible to provide the meeting session and the separate waiting session and to check whether the meeting between the exhibitor and the buyer is conducted, the meeting start time, the meeting end time, etc. by monitoring the waiting session, thereby efficiently managing the meeting.

### BRIEF DESCRIPTION OF DRAWINGS

FIG. 1 shows an online exhibition system according to exemplary embodiments of the present disclosure.

FIG. 2 is a view showing a method for managing a meeting according to the exemplary embodiments of the present disclosure.

FIG. 3 shows a management server according to the exemplary embodiments of the present disclosure.

FIG. 4 is a flowchart showing a method for operating a device according to the exemplary embodiments of the present disclosure.

FIGS. 5 to 10 are views for describing an operation of the management server according to the exemplary embodiments of the present disclosure.

FIG. 11 is a flowchart showing a method for managing a meeting in an online exhibition according to the exemplary embodiments of the present disclosure.

### DESCRIPTION OF EMBODIMENTS

In order to clearly describe the present disclosure, parts irrelevant to the description have been omitted, and the same reference numerals are given to the same or similar components throughout the specification.

Although not defined otherwise, all terms including technical terms and scientific terms used herein have the same meaning as the meaning commonly understood by those skilled in the art to which the present disclosure pertains. Commonly used terms defined in the dictionary are additionally interpreted as having a meaning consistent with the related technical literature and the currently disclosed contents, and unless defined, are not interpreted as an ideal or very formal meaning.

Hereinafter, exemplary embodiments of the present disclosure will be described in detail with reference to the accompanying drawings so that they may be easily carried out by those skilled in the art to which the present disclosure pertains. However, the present disclosure may be implemented in various different forms and is not limited to the exemplary embodiments described herein.

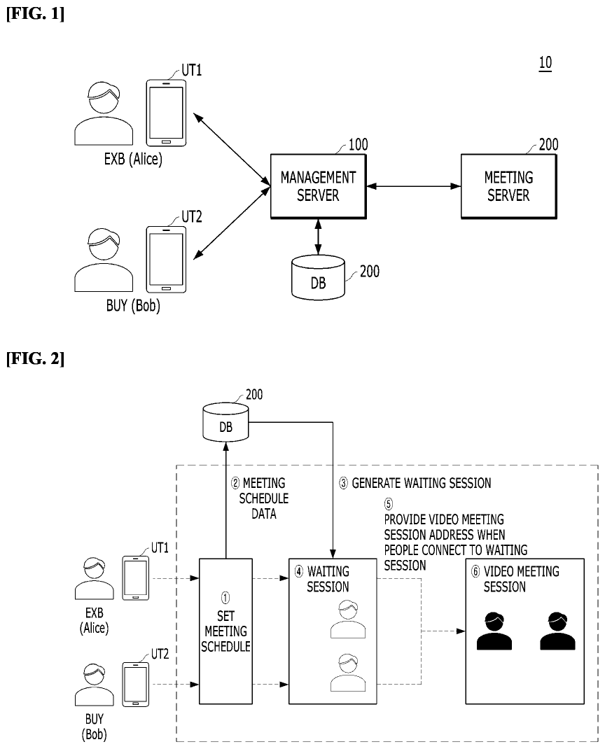

FIG. 1 shows an online exhibition system according to exemplary embodiments of the present disclosure. Referring to FIG. 1, an online exhibition system 10 may include: terminals UT1 and UT2, a management server 100, and a video meeting server 300.

The terminals UT1 and UT2 may exchange data with the management server 100. According to exemplary embodiments, an exhibitor EXB may participate in an online exhibition operated by the management server 100 by using an exhibitor terminal UT1, and a buyer BUY may participate in the online exhibition operated by the management server 100 by using a buyer terminal UT2. For example, each of the exhibitor EXB and the buyer BUY may transmit data related to the online exhibition to the management server 100 or receive the data related to the online exhibition from the management server 100 by using their own terminals UT1 and UT2.

In the online exhibition, the exhibitor EXB may promote his or her items or technologies by exhibiting or posting his or her items or technologies. In the online exhibition, the buyer BUY may consult with the exhibitor EXB to view the exhibited items or technologies of the exhibitor EXB or to inquire about the items or technologies of the exhibitor EXB, and also buy the items or the technologies.

The terminals UT1 and UT2 are computing devices having an operation processing function, and may be mobile devices or stationary devices. For example, the terminals UT1 and UT2 may mean a computer, a personal computer (PC), a smart phone, a navigation system, a laptop computer, a tablet computer, a wearable device, or a tablet, but the exemplary embodiments of the present disclosure are not limited thereto.

The terminals UT1 and UT2 may communicate with the management server 100 by using a communication method. According to the exemplary embodiments, the terminals UT1 and UT2 may exchange data with the management server 100 according to a wireless communication method or a wired communication method.

For example, the wireless communication method may include a wireless LAN (WLAN), a wireless broadband (Wibro), a wideband CDMA (WCDMA), IEEE 802.16, a Long Term Evolution (LTE), a Long Term Evolution-Advanced (LTE-A), Bluetooth, a Radio Frequency Identification (RFID), an Infrared Data Association (IrDA), an Ultra-Wideband (UWB), a ZigBee, a Near Field Communication (NFC), an Ultra Sound Communication (USC), a Visible Light Communication (VLC), Wi-Fi, etc., but is not limited thereto.

For example, a wired communication protocol may include a wired. Local Area Network (LAN), a wired Wide Area Network (WAN), a Power Line Communication (PLC), an USB communication, an Ethernet, a serial communication, an optical coaxial cable communication, etc., but is not limited thereto.

The management server 100 may be a device capable of performing a series of operations for managing a meeting between the exhibitor EXB and the buyer BUY who have participated in the online exhibition. According to the exemplary embodiments, the management server 100 may exchange data related to the meeting between the exhibitor EXB and the buyer BUY with the exhibitor terminal UT1 and the buyer terminal UT2.

According to the exemplary embodiments, the management server 100 may be a device including an integrated circuit capable of performing an operation according to a series of instructions. For example, the management server 100 may include integrated circuit elements such as a central processing unit (CPU), a graphic processing unit (GPU), an application specific integrated circuit (ASIC), a field programmable gate array (FPGA), and a micro controller unit (MCU), but is not limited thereto.

The management server 100 may access a database 200. The management server 100 may access the database 200, and write data to the database 200 or retrieve data according to the access result, but the exemplary embodiments of the present disclosure are not limited thereto. For example, the management server 100 may exchange the data related to the online exhibition with the database 200.

The database 200 may be a storage device configured to store the data. For example, the database 200 may include a non-volatile memory, a volatile memory, or a combination thereof.

The video meeting server 300 may generate a meeting session in which a video meeting is performed between the exhibitor EXB and the buyer BUY. Meanwhile, in this specification, the type of meeting is exemplarily described as the video meeting, but the exemplary embodiments of the present disclosure are not limited to the type of meeting. For example, the video meeting server 300 may generate a meeting session of the type of a text meeting, an audio meeting, or a video meeting.

According to the exemplary embodiments, the video meeting server 300 may generate the meeting session and provide a meeting session address for connecting to the meeting session. The exhibitor EXB and the buyer BUY may connect to the meeting session by using the meeting session address. For example, the terminals UT1 and UT2 may connect to the meeting session corresponding to the meeting session address. Hereinafter, in this specification, when the exhibitor EXB or the buyer BUY connects to a specific session, it means that the terminal UT1 or UT2 of the exhibitor EXB or the buyer BUY connects to (or accesses) the specific session through the session address.

The video meeting server 300 may exchange data with the terminals UT1 and UT2 that have connected to the meeting session. For example, the video meeting server 300 may mediate text data, audio data, or video data between the exhibitor terminal UT1 and the buyer terminal UT2.

According to the exemplary embodiments, the management server 100 and the meeting server 300 may be different devices. For example, the management server 100 and the meeting server 300 may be separately separated devices, or may use different networks, use different address systems, or use different domain names.

For example, a domain name of the waiting session address of the waiting session provided by the management server 100 and a domain name of the meeting session address of the meeting session provided by the meeting server 300 may be different.

For example, the management server 100 may not randomly access the network connected to the meeting server 300 and may access only a portion authorized by the meeting server 300. Likewise, the meeting server 300 may not randomly access the network connected to the management server 100 and may access only a portion authorized by the management server 100.

FIG. 2 is a view showing a method for managing a meeting according to the exemplary embodiments of the present disclosure. Referring to FIGS. 1 and 2, the management server 100 may set a meeting schedule of the exhibitor EXB and the buyer BUY and provide a meeting session address for connecting to a video meeting session corresponding to the meeting schedule. Therefore, the exhibitor EXB and the buyer BUY may conduct a mutual meeting through the management server 100.

The buyer terminal UT2 may transmit a meeting setting request including a meeting target exhibitor EXB and a desired meeting date and time to the management server 100, and the management server 100 may store the meeting schedule data including the exhibitor EXB, the buyer BUY, and the meeting date and time in response to the meeting setting request. Since the meeting in the online exhibition may be specified by the exhibitor EXB, the buyer BUY, and the meeting date and time, the meeting schedule (i.e., meeting) may be specified for each meeting setting request.

At this time, the meeting schedule data may be stored in the database 200.

The management server 100 may generate a waiting session with reference to the stored meeting schedule data. The management server 100 may generate the waiting session for each meeting specified by the exhibitor EXB, the buyer BUY, and the meeting date and time.

According to the exemplary embodiments, the management server 100 may generate the waiting session for each meeting in response to the request from the terminal (UT1 or UT2), or compare the current date and time with the meeting date and time to automatically generate the waiting session before a predetermined time from the meeting start time.

The management server 100 may generate the waiting session and transmit an address for connecting to the generated waiting session to the terminals UT1 and UT2. The exhibitor EXB and the buyer BUY may connect to the waiting session corresponding to each meeting by using the terminals UT1 and UT2.

The waiting session generated by the management server 100 may be a space in which the exhibitor EXB and the buyer BUY may wait before the meeting between the exhibitor EXB and the buyer BUY. Since the waiting session is generated and managed by the management server 100, the entrance to the waiting session of the exhibitor EXB and the buyer BUY may be monitored by the management server 100. In other words, the management server 100 may monitor whether the exhibitor EXB and the buyer BUY have participated, generate a connecting state data representing a connecting state of the exhibitor EXB and the buyer BUY (or whether they have connected to the waiting session), and store the connecting state data with respect to each of the waiting sessions.

The management server 100 may provide the address for connecting to the video meeting session. According to the exemplary embodiments, the management server 100 may transmit the address for connecting to the video meeting session to each of the terminals UT1 and UT2. Each of the exhibitor EXB and the buyer BUY may connect to the video meeting session by using the terminals UT1 and UT2 and conduct the video meeting. At this time, the video meeting between the exhibitor EXB and the buyer BUY may be managed by the video meeting server 300.

According to the exemplary embodiments, the management server 100 may transmit the address for connecting to the video meeting session to each of the terminals UT1 and UT2 when the exhibitor EXB and the buyer BUY corresponding to the waiting session exist in (or have connected to the waiting session) the waiting session with respect to each of the waiting sessions.

In other words, according to the exemplary embodiments of the present disclosure, the management server 100 may generate the waiting session in which the exhibitor EXB and the buyer BUY may wait before the meeting starts, and provide the address for connecting to the video meeting session when both the exhibitor EXB and the buyer BUY connect to the waiting session. Therefore, the management server 100 may easily know whether the exhibitor EXB and the buyer BUY have connected to the waiting session by monitoring the waiting session and provide the address for connecting to the video meeting session when both the exhibitor EXB and the buyer BUY connect to the waiting session, so that the exhibitor EXB and the buyer BUY may conduct the meeting immediately without waiting for each other when receiving the address for connecting to the video meeting session.

In addition, since the waiting session is generated and managed by the management server 100, the management server 100 may check whether the meeting between the exhibitor EXB and the buyer BUY is conducted, the meeting start time, the meeting end time, etc. by monitoring the waiting session, thereby efficiently managing the meeting. In particular, even if the management server 100 does not directly operate the meeting session, the meeting may be indirectly managed based on information about the meeting session.

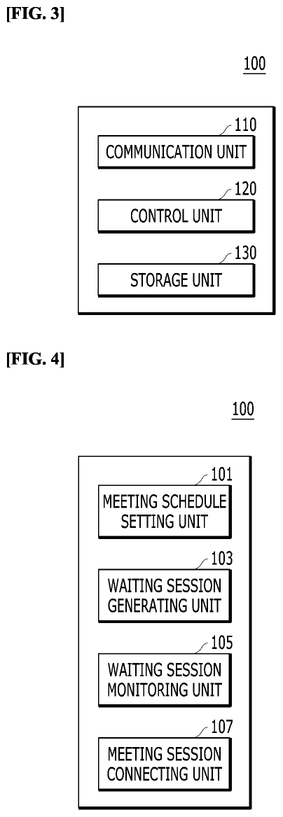

FIG. 3 shows the management server according to the exemplary embodiments of the present disclosure. Referring to FIG. 3, the management server 100 may include a communication unit 110, a control unit 120, and a storage unit 130.

The communication unit 110 may exchange data with an external device (e.g., the terminals UT1 and UT2 or the video meeting server 300). According to the exemplary embodiments, the communication unit 110 may exchange the data with the external device according to the wireless communication method or the wired communication method.

The control unit 120 may control overall operations of the management server 100. According to the exemplary embodiments, the control unit 120 may control the operation of the management server 100 by executing a program (or application) including at least one command stored in the storage unit 130 and performing operations corresponding to the program according to the execution result.

For example, the management server 100 may generate meeting schedule data representing the meeting schedule between the exhibitor EXB and the buyer BUY, generate the waiting session based on the meeting schedule data, and provide the address for connecting to the video meeting session to the exhibitor EXB and the buyer BUY who have connected to the waiting session under the control of the control unit 120.

For example, the control unit 120 may include integrated circuit elements such as a central processing unit (CPU), a graphic processing unit (GPU), an application specific integrated circuit (ASIC), a field programmable gate array (FPGA), and a micro controller unit (MCU), but is not limited thereto.

The storage unit 130 may store data necessary for operating the management server 100. According to the exemplary embodiments, the storage unit 130 may store consultation schedule data representing the consultation schedule between the exhibitor EXB and the buyer BUY, the waiting session connecting address for connecting to the waiting session, the connecting state data representing the connecting state of each of the exhibitor EXB and the buyer BUY to each of the waiting sessions, and the meeting session connecting address for connecting to the video meeting. In addition, the storage unit 130 may store a program composed of commands for performing a series of operations performed by the management server 100.

The storage unit 130 may include a non-volatile memory device or a volatile memory device. According to the exemplary embodiments, the storage unit 130 may be configured to be included in the control unit 120, but is not limited thereto.

Meanwhile, although the management server 100 and the database 200 are shown separately in FIG. 1, according to the exemplary embodiments, the database 200 may be a component included in the management server 100, and at this time, the storage unit 130 may also include the database 200.

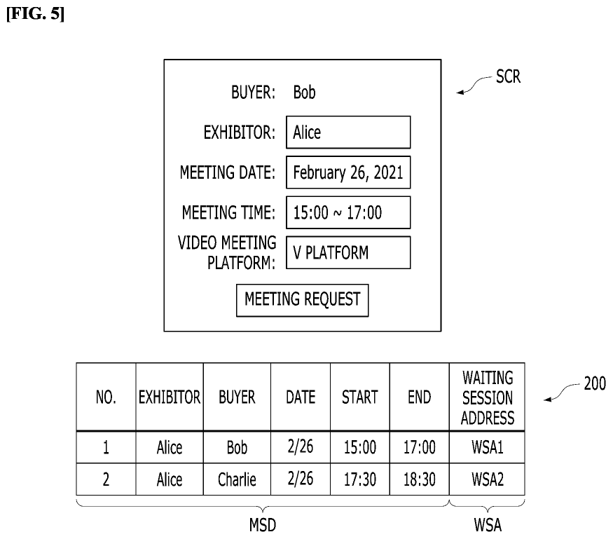

FIG. 4 shows the management server according to the exemplary embodiments of the present disclosure. Referring to FIG. 4, the management server 100 may include a meeting schedule setting unit 101, a waiting session generating unit 103, a waiting session monitoring unit 105, and a meeting session connecting unit 107.

Each of the components 101, 103, 105, and 107 of the management server 100 shown in FIG. 4 may be physically distinguished hardware. At this time, each of the components 101, 103, 105, and 107 may include a communication unit, a control unit, and a storage unit. In addition, at least two or more of the respective components 101, 103, 105, and 107 may also be integrally implemented.

In addition, each of the components 101, 103, 105, and 107 may also be a functionally distinguished module. In other words, each of the components 101, 103, 105, and 107 may mean a function block that performs each function of the control unit 120. In this case, each of the components 101, 103, 105, and 107 may mean a module that performs each function of the management server 100 performed by the operations of the communication unit 110, the control unit 120, and the storage unit 130.

The meeting schedule setting unit 101 may set the meeting schedule between the exhibitor EXB and the buyer BUY and generate the meeting schedule data representing the meeting schedule. The meeting schedule data may include information about the exhibitor EXB and the buyer BUY of the meeting and the meeting date and time. The meeting date and time may include a start time and an end time. The meeting schedule setting unit 101 may store the meeting schedule data in the database 200.

According to the exemplary embodiments, the meeting schedule setting unit 101 may set the meeting schedule between the exhibitor EXB and the buyer BUY in response to the meeting setting request from the buyer terminal UT2 and generate the meeting schedule data representing the meeting schedule, but the exemplary embodiments of the present disclosure are not limited thereto.

The waiting session generating unit 103 may generate the waiting session that may be connected by the exhibitor EXB and the buyer BUY and generate the waiting session address for connecting to the generated waiting session. The waiting session generating unit 103 may store the waiting session address in the database 200.

The waiting session generating unit 103 may generate the waiting session corresponding to the set meeting with reference to the meeting schedule data. According to the exemplary embodiments, the waiting session generating unit 103 may generate the waiting session for each set meeting schedule. For example, the waiting session generating unit 103 may generate the waiting session that may be connected only by the exhibitor and the buyer identified through the meeting schedule data.

The waiting session generating unit 103 may generate the waiting session connecting address for connecting to the waiting session and transmit the generated waiting session connecting address to the terminal UT1 or UT2. According to the exemplary embodiments, the waiting session generating unit 103 may transmit the generated waiting session connecting address to the terminal UT1 or UT2 before a predetermined time from the start time of the set meeting schedule with reference to the meeting schedule data.

The waiting session monitoring unit 105 may monitor the generated waiting session. According to the exemplary embodiments, the waiting session monitoring unit 105 may generate data related to a connector who has connected to the generated waiting session. For example, the waiting session monitoring unit 105 may generate the connecting state data representing the connecting states of the exhibitor EXB and the buyer BUY corresponding to each of the waiting sessions. The connecting state may be information related to whether there is the connection, a current connecting state, or a connecting time.

Data generated by the waiting session monitoring unit 105 may be stored in the database 200.

The meeting session connecting unit 107 may provide the meeting session address for connecting to the meeting session in which the meeting between the exhibitor EXB and the buyer BUY is conducted. According to the exemplary embodiments, the meeting session connecting unit 107 may transmit the meeting session address to the terminals UT1 and UT2. At this time, the meeting session may be generated by the meeting session connecting unit 107 or generated by the terminal UT1 or UT2. The meeting session address may be stored in the database 200.

According to the exemplary embodiments, the meeting session connecting unit 107 may transmit the meeting session address to the terminals UT1 and UT2 when both the exhibitor EXB and the buyer BUY connect to the waiting session. For example, the meeting session connecting unit 107 may determine whether the exhibitor EXB and the buyer BUY have connected to the corresponding waiting session with reference to the connecting state data stored in the database 200 and transmit the meeting session address to the terminals UT1 and UT2 when both the exhibitor EXB and the buyer BUY connect to the waiting session depending on the determination result.

According to the exemplary embodiments of the present disclosure, the management server 100 may know the connecting state of the exhibitor EXB and the buyer BUY by monitoring the waiting session and the meeting session address is provided when both the exhibitor EXB and the buyer BUY connect to the waiting session, so that the exhibitor EXB and the buyer BUY may conduct the meeting immediately without waiting for each other when receiving the meeting session address.

In addition, the waiting session is generated and managed by the management server 100, so that even if the management server 100 does not have the authority to access the meeting server 300, the management server 100 may check whether the meeting between the exhibitor EXB and the buyer BUY is conducted, the meeting start time, the meeting end time, etc. by monitoring the waiting session, thereby indirectly managing the meeting.

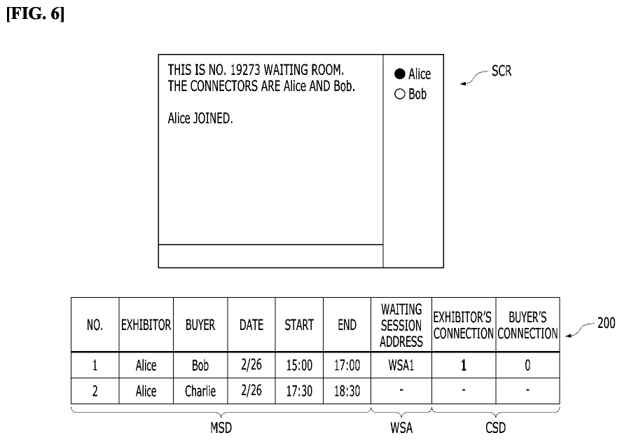

FIGS. 5 to 10 are views for describing an operation of the management server according to exemplary embodiments of the present disclosure.

FIG. 5 exemplarily shows a screen SCR displayed through the buyer terminal UT2 and a structure of the database 200. Referring to FIG. 5, the management server 100 may set the meeting schedule between the exhibitor EXB and the buyer BUY. The management server 100 may set the meeting schedule and generate meeting schedule data MSD representing the meeting schedule. The management server 100 may store the meeting schedule data MSD in the database 200.

For example, the management server 100 may provide a user interface for setting the meeting schedule between the exhibitor ‘Alice’ and the buyer ‘Bob’ to the terminal UT1 or UT2. Bob may select the meeting date and time, the meeting time, and the meeting platform by using the terminal UT2 and then click (or touch) the meeting request button to transmit the meeting setting request including information about the meeting date, the meeting time, and the meeting platform to the management server 100.

For example, the management server 100 may generate the meeting schedule data MSD including information about the exhibitor ‘Alice’, the buyer ‘Bob’, the meeting date ‘2/26’, the meeting start time ‘15:00’, and the meeting end time ‘17:00’ in response to the meeting request and store the generated meeting schedule data MSD in the database 200. According to the exemplary embodiments, the meeting schedule data MSD representing a plurality of meeting schedules may also be stored in the database 200.

In addition, the management server 100 may generate the waiting session for each of the meeting schedules based on the meeting schedule data MSD and store the waiting session address WSA for connecting to the generated waiting session in the database 200. At this time, the database 200 may match the meeting schedule data MSD with the waiting session address WSA to store them. For example, the management server 100 may transmit a query including the meeting schedule data MSD to the database 200 and the database 200 may transmit the response including the waiting session address WSA corresponding to the meeting schedule data MSD to the management server 100 in response to the corresponding query.

For example, the management server 100 may generate the waiting session for the meeting corresponding to the exhibitor ‘Alice’, the buyer ‘Bob’, the meeting date ‘2/26’, the meeting start time ‘15:00’, and the meeting end time ‘17:00’ and store the waiting session address ‘WSA1’. The management server 100 may transmit the generated waiting session address to the terminals UT1 and UT2 so that the exhibitor EXB and the buyer BUY may connect to the waiting session.

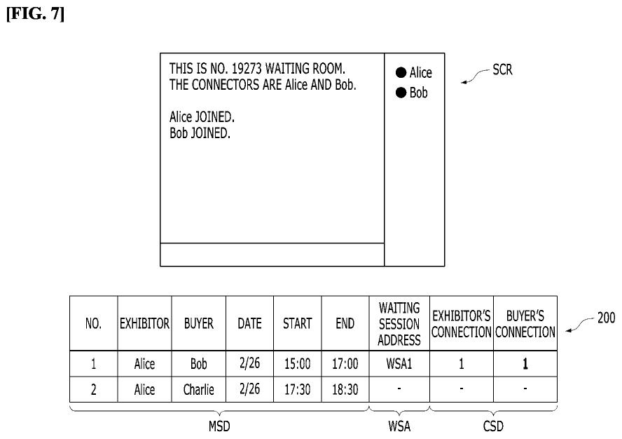

FIG. 6 exemplarily shows the screen SCR displayed through the exhibitor terminal UT1 and the structure of the database 200. Referring to FIG. 6, for example, the exhibitor Alice may connect to the waiting session according to the transmitted waiting session address by using the exhibitor terminal UT1. According to the exemplary embodiments, whether Alice has connected to the waiting session may be checked in the waiting session.

The management server 100 may identify the connector who connects to the waiting session and monitor whether the exhibitor EXB and the buyer BUY have participated depending on the identification result. The management server 100 may generate the connecting state data CSD representing the connecting state of the waiting session of the exhibitor EXB and the buyer BUY (or whether they have connected to the waiting session) and store the connecting state data CSD in the database 200. At this time, the database 200 may match the waiting session address WSA with the connecting state data CSD to store them. For example, the management server 100 may transmit the query including the waiting session address WSA to the database 200 and the database 200 may transmit the response including the connecting state data CSD corresponding to the waiting session address WSA to the management server 100 in response to the corresponding query.

For example, the management server 100 may generate the connecting state data CSD representing that the exhibitor Alice has connected to the waiting session defined by the waiting session address WSA1. At this time, the connecting state data CSD may include the exhibitor connecting flag representing whether the exhibitor Alice has connected to the waiting session. At this time, the exhibitor connecting flag may be 1 bit of data.

For example, the management server 100 may monitor the waiting session, identify the connector (or connecting terminal) who connects to the waiting session, and change and store the exhibitor connecting flag representing whether Alice has connected to the waiting session from ‘0’ to ‘1’ when the connector is identified as the exhibitor Alice depending on the identification result.

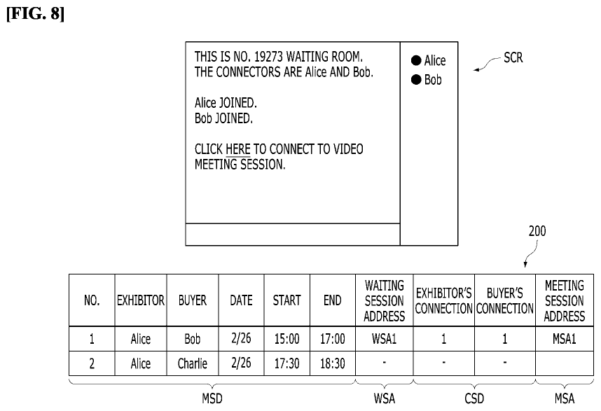

FIG. 7 exemplarily shows the screen SCR displayed through the exhibitor terminal UT1 and the structure of the database 200. Referring to FIG. 7, for example, after the connection of the exhibitor Alice, the buyer Bob may connect to the waiting session according to the transmitted waiting session address by using the buyer terminal UT2. According to the exemplary embodiments, whether Bob has connected to the waiting session may be checked in the waiting session.

For example, the management server 100 may generate the connecting state data CSD representing that the buyer Bob has connected to the waiting session defined by the waiting session address WSA1. At this time, the connecting state data CSD may include the buyer connecting flag representing whether the buyer Bob has connected to the waiting session. At this time, the buyer connecting flag may be 1-bit of data.

For example, the management server 100 may monitor the waiting session, identify the connector who connects to the waiting session, and change and store the flag representing whether Bob has connected to the waiting session from ‘0’ into ‘1’ when the connector is identified as the buyer Bob depending on the identification result. Therefore, the flag representing whether Bob stored in the database 200 has connected to the waiting session may be changed from ‘0’ to ‘1’.

FIG. 8 exemplarily shows the screen SCR displayed through the exhibitor terminal UT1 and the structure of the database 200. Referring to FIG. 8, the management server 100 may provide the meeting session address MSA for connecting to the video meeting session for conducting the video meeting between the exhibitor EXB and the buyer BUY. According to the exemplary embodiments, the management server 100 may transmit the meeting session address MSA to the terminals UT1 and UT2 of the exhibitor EXB and the buyer BUY who have connected to the waiting session.

According to the exemplary embodiments of the present disclosure, the management server 100 may transmit the meeting session address MSA to the terminals UT1 and UT2 when both the exhibitor EXB and the buyer BUY connect to the waiting session. According to the exemplary embodiments, the management server 100 may transmit the meeting session address MSA to the terminals UT1 and UT2 when both the exhibitor EXB and the buyer BUY connect to the corresponding waiting session based on the connecting state data CSD stored in the database 200.

At this time, the meeting session address MSA may be stored in connection with the corresponding meeting schedule.

For example, the management server 100 may determine whether both the exhibitor Alice and the buyer Bob have connected to the waiting session based on the connecting state data CSD representing the connecting state of the waiting session defined by the waiting session address WSA1. For example, the management server 100 may determine whether both the exhibitor Alice and the buyer Bob have connected to the waiting session by using the exhibitor connecting flag representing whether Alice has connected to the waiting session and the buyer connecting flag representing whether Bob has connected to the waiting session stored in the database 200. The management server 100 may determine that both the exhibitor Alice and the buyer Bob have connected to the waiting session when both the exhibitor connecting flag representing whether Alice has connected to the waiting session and the buyer connecting flag representing whether Bob has connected to the waiting session are ‘1’ and transmit the meeting session address MSA1 to the terminals UT1 and UT2 of the exhibitor Alice and the buyer Bob. For example, the management server 100 may transmit the meeting session address MSA1 to the terminals UT1 and UT2 of the exhibitor Alice and the buyer Bob depending on an AND operation result of the exhibitor connecting flag representing whether Alice has connected to the waiting session and the buyer connecting flag representing whether Bob has connected to the waiting session.

According to the exemplary embodiments, the management server 100 may not transmit the meeting session address MSA to the terminals UT1 and UT2 when at least one of the exhibitor EXB and the buyer BUY does not connect to the waiting session. For example, the management server 100 may not read the meeting session address MSA from the database 200 when at least one of the exhibitor EXB and the buyer BUY does not connect to the waiting session.

For example, the management server 100 may determine whether each meeting has been normally conducted depending on whether it has transmitted the meeting session address MSA to the terminals UT1 and UT2 with respect to each of the waiting sessions. For example, when the management server 100 transmits the meeting session address MSA to the terminals UT1 and UT2, the management server 100 may store a transmission record and determine whether each meeting has been normally conducted based on the transmission record.

According to the exemplary embodiments of the present disclosure, the management server 100 may easily know whether the exhibitor EXB and the buyer BUY have connected to the waiting session by monitoring the waiting session and the address for connecting to the video meeting session is provided when both the exhibitor EXB and the buyer BUY connect to the waiting session, so that the exhibitor EXB and the buyer BUY may conduct the meeting immediately without waiting for each other when receiving the address for connecting to the video meeting session.

FIG. 9 exemplarily shows the screen SCR displayed through the exhibitor terminal UT1 and the structure of the database 200. Referring to FIG. 9, the management server 100 may provide the address for writing the meeting review to the exhibitor EXB and the buyer BUY through the waiting session.

According to the exemplary embodiments, the management server 100 may transmit the meeting session address MSA and then transmit the address for writing the meeting review to the terminals UT1 and UT2 of the exhibitor EXB and the buyer BUY who have connected to the corresponding waiting session.

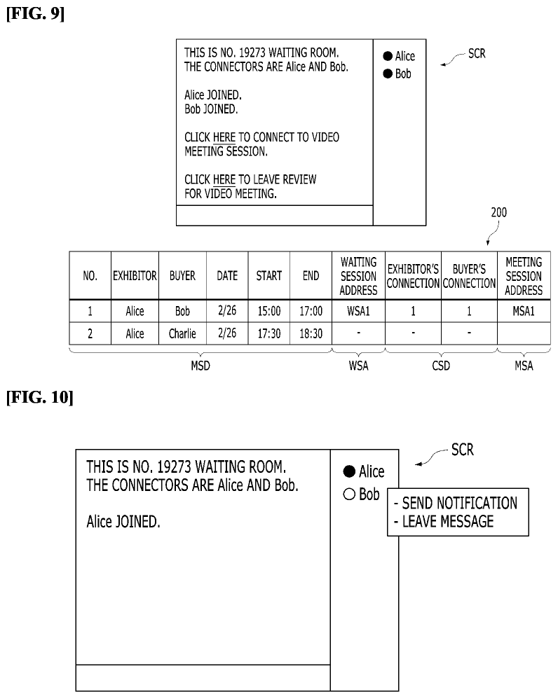

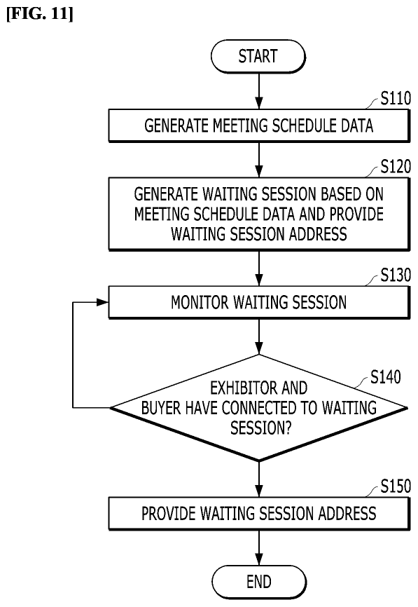

FIG. 10 exemplarily shows the screen SCR displayed through the exhibitor terminal UT1. Referring to FIG. 10, the management server 100 may provide functions related to the exhibitor EXB and the buyer BUY of the set meeting schedule.

According to the exemplary embodiments, the management server 100 may provide a notification to the terminal UT1 or UT2 of the exhibitor EXB or the buyer BUY. For example, the exhibitor Alice may transmit a notification transmission request to the management server 100 by using her terminal UT1, and the management server 100 may transmit the notification notifying that the buyer Bob has not connected to the waiting session to the Bob's terminal UT2 in response to the notification transmission request. In

addition, for example, the management server 100 may transmit the notification to the terminal UT1 or UT2 of the exhibitor EXB or the buyer BUY who has not connected to the waiting session when the exhibitor EXB or the buyer BUY does not connect to the waiting session even after a predetermined time elapses from the meeting start time with respect to each of the waiting sessions.

According to the exemplary embodiments, the management server 100 may provide information about the exhibitor EXB or the buyer BUY to the counterpart. For example, the exhibitor Alice may transmit the message transmission request to the management server 100 by using her terminal UT1, and the management server 100 may transmit the message of the exhibitor Alice to the terminal UT2 of the buyer Bob in response to the message transmission request.

According to the exemplary embodiments of the present disclosure, the management server 100 may transmit the notification or the message to the exhibitor EXB and the buyer BUY through the waiting session, thereby preventing the no-show phenomenon in which one of the exhibitor EXB and the buyer BUY does not participate in the meeting.

FIG. 11 is a flowchart showing a method for managing the meeting in an online exhibition according to the exemplary embodiments of the present disclosure. Steps or operations described with reference to FIG. 11 may be performed by the management server 100. In addition, a program for performing the steps or operations described with reference to FIG. 11 may be stored in a computer-readable non-transitory storage medium.

Referring to FIG. 11, the management server 100 may generate the meeting schedule data (S110). According to the exemplary embodiments, the management server 100 may set the meeting schedule between the exhibitor EXB and the buyer BUY and generate the meeting schedule data representing the meeting schedule.

The management server 100 may generate the waiting session based on the meeting schedule data and provide the waiting session address (S120). According to the exemplary embodiments, the management server 100 may generate the meeting session corresponding to each of the meeting schedules and transmit the meeting session address for connecting to the generated meeting session to the terminals UT1 and UT2 of the exhibitor EXB and the buyer BUY of each meeting schedule.

The management server 100 may monitor the waiting session (S130). According to the exemplary embodiments, the management server 100 may transmit the waiting session address to the terminals UT1 and UT2 of the exhibitor EXB and the buyer BUY of each meeting schedule and generate the connecting state data representing the connecting state by monitoring the connecting state of the corresponding waiting session.

The management server 100 may determine whether both the exhibitor and the buyer have connected to the waiting session (S140). According to the exemplary embodiments, the management server 100 may determine whether the exhibitor EXB and the buyer BUY have connected to the corresponding waiting session based on the connecting state data.

When it is determined that the exhibitor EXB and the buyer BUY have connected to the waiting session (Y in S140), the management server 100 may provide the meeting session address for connecting to the meeting session in which the meeting between the exhibitor EXB and the buyer BUY is conducted (S150). For example, the management server 100 may transmit the meeting session address to the terminals UT1 and UT2 when both the exhibitor EXB and the buyer BUY connect to the waiting session.

When it is determined that the exhibitor EXB or the buyer BUY has not connected to the corresponding waiting session (N in S140), the management server 100 may continuously monitor the waiting session. For example, the management server 100 may provide the notification or the message for inducing the connection to the exhibitor EXB or the buyer BUY who has not yet connected to the waiting session.

According to the exemplary embodiments of the present disclosure, the management server 100 may know the connecting state of the exhibitor EXB and the buyer BUY by monitoring the waiting session and the meeting session address is provided when both the exhibitor EXB and the buyer BUY connect to the waiting session, so that the exhibitor EXB and the buyer BUY may conduct the meeting immediately without waiting for each other when receiving the meeting session address.

As described above, although the exemplary embodiments have been described with reference to the limited exemplary embodiments and drawings, various modifications and changes are possible by those skilled in the art from the above description. For example, even if the described technologies are performed in an order different from the described method, and/or the components of the described system, structure, device, circuit, etc. are coupled or combined in different forms from the described method or are replaced or substituted by other components or equivalents, an appropriate result may be achieved.

Therefore, other implementations, other exemplary embodiments, and those equivalent to the claims also fall within the scope of the appended claims.

1. A device for managing a meeting between an exhibitor and a buyer in a virtual exhibition, the device comprising:
a communication unit configured to exchange data with an exhibitor terminal of the exhibitor and a buyer terminal of the buyer;
a storage unit configured to store at least one command; and
a control unit configured to control the device according to the at least one command,
wherein the device generates meeting schedule data representing a meeting schedule between the exhibitor and the buyer, stores the meeting schedule data in a database,
generates a waiting session based on the meeting schedule data, transmits a waiting session address for connecting to the waiting session to the exhibitor terminal and the buyer terminal, and
transmits a meeting session address for connecting to the meeting session in which the meeting between the exhibitor and the buyer is conducted to the exhibitor terminal and the buyer terminal when the exhibitor terminal and the buyer terminal connect to the waiting session under the control of the control unit.

2. The device of claim 1, wherein the meeting schedule data comprises: information about an exhibitor, a buyer, and a meeting date and time of the corresponding meeting.

3. The device of claim 1,
wherein the meeting session is generated by a separate device separated from the device, and
wherein a domain name of the meeting session address and a domain name of the waiting session address are different from each other.

4. The device of claim 1, wherein the device generates the meeting schedule data in response to a request signal from the exhibitor terminal or the buyer terminal,
generates the waiting session based on the meeting schedule data,
monitors the waiting session, generates a connecting state data representing a connecting state of the waiting session of the exhibitor terminal and the buyer terminal, stores the generated connecting state data in the database,
determines whether the exhibitor terminal and the buyer terminal have connected to the waiting session based on the connecting state data, and transmits the meeting session address to the exhibitor terminal and the buyer terminal depending on the determination result under the control of the control unit.

5. The device of claim 1, wherein the meeting schedule data comprises: information about an exhibitor, a buyer, and a meeting date and time of the corresponding meeting.

6. The device of claim 5, wherein the device transmits the waiting session address to the exhibitor terminal and the buyer terminal before a predetermined time from a start time of a set meeting schedule by using the meeting schedule data under the control of the control unit.7

7. The device of claim 4, wherein the device generates an exhibitor connecting flag representing whether the exhibitor terminal has connected to the waiting session,
generates a buyer connecting flag representing whether the buyer terminal has connected to the waiting session, and
generates the connecting state data comprising the exhibitor connecting flag and the buyer connecting flag under the control of the control unit.

8. The device of claim 7, wherein the device monitors a connecting terminal that connects to the waiting session,
changes a flag representing whether the exhibitor terminal has connected to the waiting session when the exhibitor terminal connects to the waiting session, and
changes a flag representing whether the buyer terminal connects to the waiting session when the buyer terminal connects to the waiting session under the control of the control unit.

9. The device of claim 7, wherein the device determines whether the exhibitor terminal has connected to the waiting session based on the exhibitor connecting flag,
determines whether the buyer terminal has connected to the waiting session based on the buyer connecting flag, and
transmits the meeting session address to the exhibitor terminal and the buyer terminal when it is determined that both the exhibitor terminal and the buyer terminal have connected to the waiting session under the control of the control unit.

10. The device of claim 9,
wherein the exhibitor connecting flag and the buyer connecting flag are 1 bit of data, and
wherein the device performs an AND operation for the exhibitor connecting flag and the buyer connecting flag, and determines whether the exhibitor terminal and the buyer terminal have connected to the waiting session depending on the operation result under the control of the control unit.

11. The device of claim 4, wherein the device reads the meeting session address corresponding to the corresponding meeting schedule from the database when it is determined that both the exhibitor terminal and the buyer terminal have connected to the waiting session and transmits the read meeting session address under the control of the control unit.

12. A method for operating a device for managing a meeting between an exhibitor and a buyer in a virtual exhibition, the method comprising:
generating a meeting schedule data representing a meeting schedule between an exhibitor and a buyer in response to a request from an exhibitor terminal of the exhibitor or a buyer terminal of the buyer and storing the meeting schedule data in a database;
generates a waiting session based on the meeting schedule data and transmitting a waiting session address for connecting to the waiting session to the exhibitor terminal and the buyer terminal;
monitoring whether the exhibitor terminal and the buyer terminal have connected to the waiting session; and
transmitting a meeting session address for connecting to a meeting session in which a meeting between the exhibitor and the buyer is conducted to the exhibitor terminal and the buyer terminal when the exhibitor terminal and the buyer terminal connect to the waiting session.

13. The method of claim 12, wherein the monitoring comprises:
monitoring the waiting session and generating a connecting state data representing a connecting state of the waiting session of the exhibitor terminal and the buyer terminal; and
storing the generated connecting state data in the database.

14. The method of claim 13, wherein the generating of the connecting state data comprises:
generating an exhibitor connecting flag representing whether the exhibitor terminal has connected to the waiting session;
generating a buyer connecting flag representing whether the buyer terminal has connected to the waiting session; and
generating the connecting state data comprising the exhibitor connecting flag and the buyer connecting flag.

15. The method of claim 14, wherein the transmitting of the meeting session address to the exhibitor terminal and the buyer terminal comprises:
determining whether the exhibitor terminal has connected to the waiting session based on the exhibitor connecting flag;
determining whether the buyer terminal has connected to the waiting session based on the buyer connecting flag; and
transmitting the meeting session address to the exhibitor terminal and the buyer terminal when it is determined that both the exhibitor terminal and the buyer terminal have connected to the waiting session.
